(19) United States
(12) Patent Application Publication
(10) Pub. No.: US 2024/0276308 A1
(43) Pub. Date: Aug. 15, 2024

(54) WIRELESS TERMINAL CONNECTION CONTROL METHOD

(71) Applicant: Nippon Telegraph and Telephone Corporation, Tokyo (JP)

(72) Inventors: Masayoshi NABESHIMA, Musashino-shi, Tokyo (JP); Tomoki MURAKAMI, Musashino-shi, Tokyo (JP); Tomoaki OGAWA, Musashino-shi, Tokyo (JP); Hideki OGAWA, Musashino-shi, Tokyo (JP); Taichi KAWANO, Musashino-shi, Tokyo (JP)

(21) Appl. No.: 18/567,213

(22) PCT Filed: Jun. 8, 2021
(86) PCT No.: PCT/JP2021/021720

§ 371 Date: Dec. 5, 2023

(51) Int. Cl. H04W 28/24; H04W 48/16; H04W 84/12

(52) U.S. Cl. CPC H04W 28/24; H04W 48/16; H04W 84/12

(57) ABSTRACT

A wireless terminal connection control method evaluates QoE prior to connection of a wireless terminal to a wireless LAN, and permits connection to the wireless LAN in a case where QoE of a predetermined level or higher can be guaranteed. First, a QoE value indicating the wireless communication quality felt by the user is received from each wireless terminal connected to the wireless LAN access point. Next, an overall QoE value is calculated based on each received QoE value. Then, connection between the wireless LAN access point and the wireless terminal in the non-connected state is permitted in a case where there is a connection request from the wireless terminal in the non-connected state to the wireless LAN access point to the wireless LAN access point and in a case where the overall QoE value is equal to or greater than a threshold value.

### TECHNICAL FIELD

The present invention relates to a wireless terminal connection control method, and more particularly, to a technology for providing a wireless service to a wireless terminal having wireless interfaces for both a wireless LAN and a public mobile communication network.

### BACKGROUND ART

An access point of a wireless LAN is installed in a station or a convenience store. Recent wireless terminals have both wireless interfaces of a wireless LAN and a public mobile communication network. The wireless terminal is connected to an access point of a wireless LAN in expectation of reduction in communication volume in a public mobile communication network and improvement in wireless communication quality. Conventionally, a technique for automatically switching connection from a public mobile communication network to a wireless LAN has been studied. The access point controls whether or not to permit a wireless terminal that attempts to connect to the access point itself to connect. For example, Non Patent Literature 1 discloses a technique in which an access point rejects connection from a wireless terminal at a certain electric field level or lower.

### CITATION LIST

### Non Patent Literature

Non Patent Literature 1: AP (EA-7HW03AP1) Instruction manual (settings), commercial Wi-Fi base station, 4.3.4 terminal connection control setting, manufactured by Panasonic Corporation
Non Patent Literature 2: Toshiko Tominaga, Kanako Sato, Noriko Yoshimura, Masatake Masuda, Hitoshi Aoki, Takanori Hayashi, “Web-Browsing QoE Estimation Model”, IEICE Trans. On Communications, Vol. E100.B, No. 10, pp. 1837-1845, 2017. Non Patent Literature 3: Okamoto, Hayashi, “Latest Trends in Image Media Quality Assessment Technologies,” Institute of Electronics, Information and Communication Engineers, Engineering Sciences, Society Fundamentals Reviews, 276-284, 2013

### SUMMARY OF INVENTION

### Technical Problem

However, the conventional wireless interface switching technology has a problem that usability may deteriorate after switching to the wireless LAN. The usability is the same as the quality experience by the user (Quality of Experience: QoE). A wireless terminal connection control method for permitting connection of a wireless terminal based on QoE is desired.

The present invention has been made to solve the above-described problems, and an object of the present invention is to provide a wireless terminal connection control method capable of evaluating QoE prior to connection of a wireless terminal to a wireless LAN and permitting connection to the wireless LAN when a QoE of a predetermined level or higher can be guaranteed.

### Solution to Problem

A first aspect relates to a wireless terminal connection control method for a wireless LAN access point and a plurality of wireless terminals having wireless interfaces of both a wireless LAN and a public mobile communication network.

The wireless terminal connection control method includes a QoE reception step, an overall QoE calculation step, and a connection permission step.

In the QoE reception step, a QoE value indicating the wireless LAN communication quality experienced by the user is received from each wireless terminal connected to the wireless LAN access point.

In the overall QoE calculation step, an overall QoE value is calculated based on each received QoE value.

In the connection permission step, connection between the wireless LAN access point and the wireless terminal in a non-connected state is permitted in a case where there is a connection request from the wireless terminal in the non-connected state with the wireless LAN access point to the wireless LAN access point and in a case where the overall QoE value is equal to or greater than a threshold value.

### Advantageous Effects of Invention

According to the present invention, a wireless LAN access point evaluates the QoE of an already connected wireless terminal prior to connection of a new wireless terminal to the wireless LAN access point. In a case where the QoE of a predetermined level or higher can be guaranteed, the wireless LAN access point permits the new wireless terminal to be connected to the wireless LAN access point. Therefore, it is possible to suppress deterioration in usability of the wireless terminal felt by the user after connection to the wireless LAN access point.

### BRIEF DESCRIPTION OF DRAWINGS

FIG. 1 is a conceptual diagram for illustrating an outline of a wireless communication system according to a first embodiment of the present invention.

FIG. 2 is a flowchart for illustrating processing of an overall QoE calculation unit according to the first embodiment of the present invention.

FIG. 3 is a flowchart for illustrating processing of a connection permission unit according to the first embodiment of the present invention.

FIG. 4 is a timing chart for illustrating a specific example according to each embodiment of the present invention.

FIG. 5 is a flowchart for illustrating processing of an overall QoE calculation unit according to a second embodiment of the present invention.

FIG. 6 is a flowchart for illustrating processing of a connection permission unit according to the second embodiment of the present invention.

FIG. 7 is a graph of a function f (rssi) according to a third embodiment of the present invention.

FIG. 8 is a flowchart for illustrating a connection permission unit 22 according to the third embodiment of the present invention.

FIG. 9 is a block diagram illustrating a configuration example of a wireless terminal 1 and an access point 2 according to the present embodiment.

### DESCRIPTION OF EMBODIMENTS

Hereinafter, embodiments of the present invention will be described in detail with reference to the drawings. Note that elements common in the drawings are denoted by the same reference numerals, and redundant description will be omitted.

### First Embodiment

### (1) Wireless Communication System

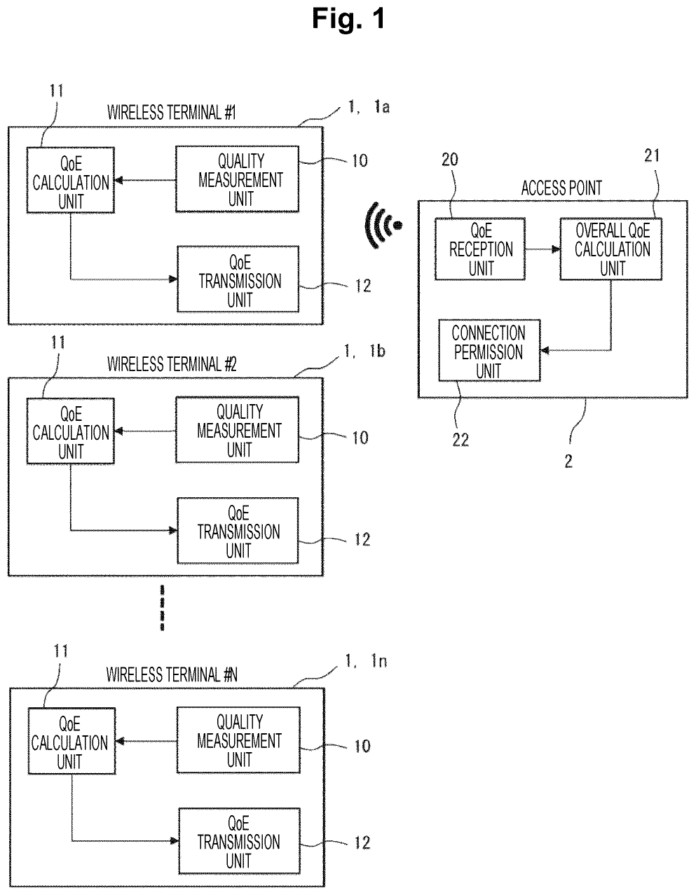

FIG. 1 is a conceptual diagram for explaining an outline of a wireless communication system according to a first embodiment. The wireless communication system illustrated in FIG. 1 includes a plurality of wireless terminals 1 and an access point 2. FIG. 1 illustrates a first wireless terminal 1a, a second wireless terminal 1b, and an N-th wireless terminal 1n as the wireless terminal 1.

### (2) Wireless Terminal

Each wireless terminal 1 has wireless interfaces of both a wireless LAN and a public mobile communication network, and can switch a connection destination between the wireless LAN and the public wireless communication network. Each wireless terminal 1 includes a quality measurement unit 10, a QoE calculation unit 11, and a QoE transmission unit 12.

The quality measurement unit 10 measures a Web waiting time (a time from the start of reading a web page to the end of reading the web page). The Web waiting time is a value obtained by acquiring the values of “loadEventEnd” and “navigationStart” via the Navigation Timing API which is a browser standard API and subtracting “navigationStart” from “loadEventEnd”. The calculated Web waiting time is notified to the QoE calculation unit 11.

The QoE calculation unit 11 calculates a degradation mean opinion score (DMOS), which is a QoE value, from the notified Web waiting time by Equation (1) below disclosed in Non Patent Literature 2. Here, t is a Web waiting time. The QoE calculation unit 11 notifies the QoE transmission unit 12 of the calculated QoE value.

$$\begin{matrix}[ Math . 1 ] & \\ 4.179 \times exp ( \frac{- t}{9.524} ) + 1. & ( 1 )\end{matrix}$$

The quality evaluation value indicated by the QoE (DMOS) value is classified into the following five levels (Non Patent Literature 3).
5: Deterioration is imperceptible.
4: Deterioration is perceptible but not annoying.
3: Deterioration is perceptible and slightly annoying.
2: Deterioration is perceptible and annoying.
1: Deterioration is perceptible and very annoying.

The QoE transmission unit 12 transmits the notified QoE value to the access point 2.

### (3) Access Point

The access point 2 is a wireless LAN access point, and includes a QoE reception unit 20, an overall QoE calculation unit 21, and a connection permission unit 22.

The QoE reception unit 20 receives the QoE value from each wireless terminal 1 connected to the wireless LAN (access point 2) and notifies the overall QoE calculation unit 21 of the value.

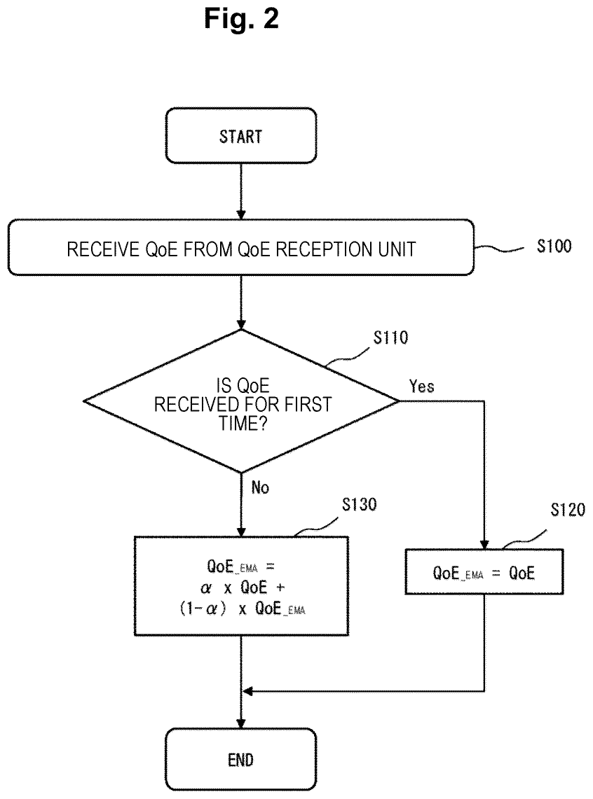

The processing of the overall QoE calculation unit 21 illustrated in FIG. 1 will be described with reference to FIG. 2.

The overall QoE calculation unit 21 calculates an overall QoE value based on each received QoE value. In the first embodiment, the overall QoE value is an exponential moving average (EMA) of the received QoE values. The overall QoE calculation unit 21 calculates an overall QoE value (QoE_{EMA}) using the exponential moving average expressed by Equation (2) below, with emphasis on recent QoE values and without completely discarding old QoE values. Here, a is a constant from 0 to 1.

$$\begin{matrix}[ Math . 2 ] & \\ {Q}^{} {oE}_{EMA} = α \times QoE + ( 1 - α ) \times {QoE}_{EMA} & ( 2 )\end{matrix}$$

FIG. 2 is a flowchart for illustrating the overall QoE calculation unit 21 according to the first embodiment. The flow illustrated in FIG. 2 is performed each time the access point 2 receives a QoE value from the wireless terminal 1.

In step S100, the overall QoE calculation unit 21 receives the QoE value from the QoE reception unit 20.

In step S110, the overall QoE calculation unit 21 determines whether a QoE value has been received for the first time. In a case where the reception of the QoE value is the first time, the processing of step S120 is executed. On the other hand, in a case where the reception of the QoE value is the second and subsequent times, the processing of step S130 is executed.

In step S120, the overall QoE calculation unit 21 substitutes the first received QoE value for the overall QoE value (QoE_{EMA}).

In step S130, the overall QoE calculation unit 21 updates the overall QoE value (QoE_{EMA}) using the exponential moving average shown in Equation (2) above.

Thereafter, the overall QoE calculation unit 21 notifies the connection permission unit 22 of the overall QoE value.

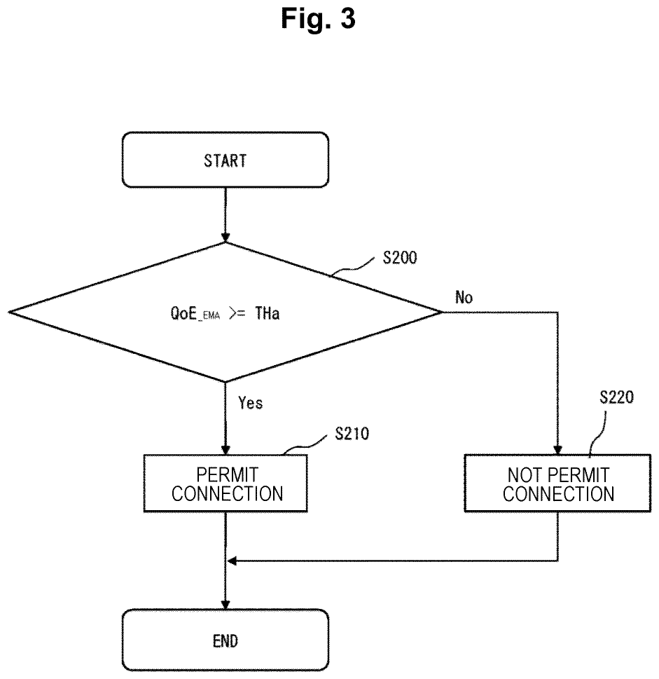

Processing of the connection permission unit 22 illustrated in FIG. 1 will be described with reference to FIG. 3.

The connection permission unit 22 permits connection between the access point 2 and the wireless terminal 1 in the non-connected state in a case where there is a connection request from the wireless terminal 1 in the non-connected state with the access point 2 to the access point 2 and in a case where the overall QoE value is equal to or greater than a threshold value.

FIG. 3 is a flowchart for illustrating the connection permission unit 22 according to the first embodiment. The flow illustrated in FIG. 3 is performed each time the access point 2 receives a connection request signal from the wireless terminal 1.

In step S200, the connection permission unit 22 determines whether the overall QoE value (QoE_{EMA}) is equal to or greater than a predetermined threshold value THa. The threshold value THa is a quality evaluation value of five levels from 1 to 5 described above. For example, setting the threshold value THa to 3 means that new connection is permitted only when the exponential moving average of QoE of the wireless terminal 1 connected to the access point 2 is equal to or greater than normal (THa=3).

In a case where the overall QoE value (QoE_{EMA}) is equal to or greater than the threshold value THa, the wireless terminal 1 connected to the access point 2 can be guaranteed QoE of a predetermined level or higher. Therefore, the connection permission unit 22 permits a new connection in step S210. Thereafter, the wireless terminal 1 is newly connected to the access point 2.

On the other hand, in a case where the overall QoE value (QoE_{EMA}) is less than the threshold value THa, the wireless terminal 1 connected to the access point 2 cannot be guaranteed a QoE of a predetermined level or higher. Therefore, the connection permission unit 22 does not permit a new connection in step S220.

### (4) Specific Example

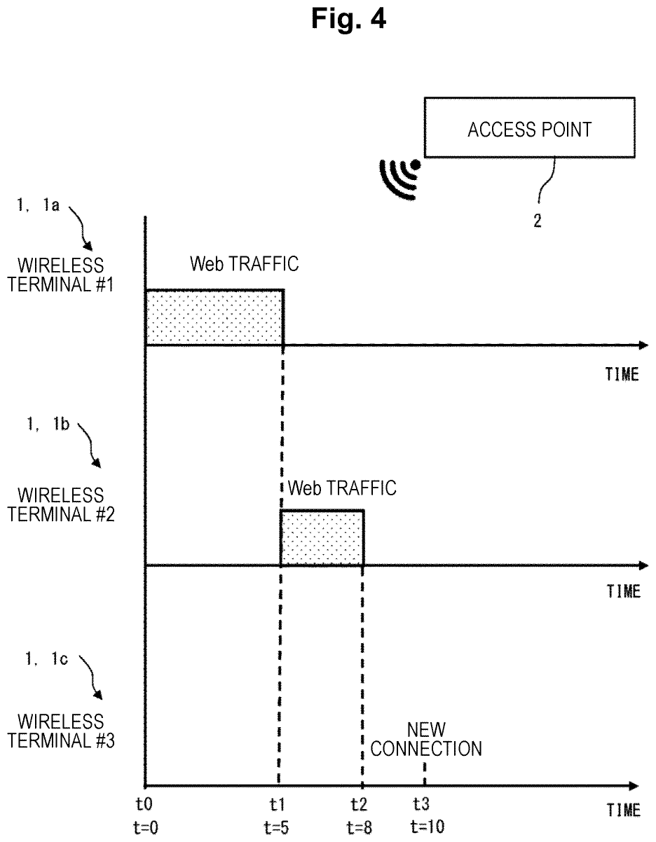

A specific example of connection processing based on the QoE described above in the wireless communication system according to the first embodiment will be described with reference to FIG. 4.

In the example illustrated in FIG. 4, the number of access points 2 is one. The first wireless terminal 1a and the second wireless terminal 1b are connected to the access point 2. The first wireless terminal 1a and the second wireless terminal 1b receive Web traffic as illustrated in FIG. 4. In addition, the third wireless terminal 1c is not connected to the access point 2 and is connected to the public mobile communication network at time t3. The third wireless terminal 1c attempts a new connection to the access point 2 at the time t3. In this specific example, the overall QoE calculation unit 21 follows the flowchart of FIG. 2, and the connection permission unit 22 follows the flowchart of FIG. 3.

At time t1 (5 seconds after time to), the quality measurement unit 10 of the first wireless terminal 1a notifies the QoE calculation unit 11 of the Web waiting time (5 seconds). The QoE calculation unit 11 calculates the QoE value as follows according to Equation (1) above.

$$QoE = 4.179 \times exp ( ( - 5 ) / 9.524 ) + 1. = 3.47$$

The QoE calculation unit 11 notifies the QoE transmission unit 12 of the calculated QoE value (=3.47). The QoE transmission unit 12 transmits the notified QoE value (=3.47) to the access point 2.

The QoE reception unit 20 of the access point 2 receives the QoE value (=3.47) from the first wireless terminal 1 and notifies the overall QoE calculation unit 21 of the value.

The overall QoE calculation unit 21 calculates an overall QoE value in accordance with the flowchart of FIG. 2. Since the overall QoE calculation unit 21 receives the QoE value for the first time, it substitutes the received QoE value (=3.47) for the overall QoE value (step S120). The overall QoE calculation unit 21 notifies the connection permission unit 22 of the calculated overall QoE value (=3.47).

At time t2 (8 seconds after time to), the quality measurement unit 10 of the second wireless terminal 1b notifies the QoE calculation unit 11 of the Web waiting time (3 seconds). The QoE calculation unit 11 calculates the QoE value as follows according to Equation (1) above.

$$QoE = 4.179 \times exp ( ( - 3 ) / 9.524 ) + 1. = 4.05$$

The QoE calculation unit 11 notifies the QoE transmission unit 12 of the calculated QoE value (=4.05). The QoE transmission unit 12 transmits the notified QoE value (=4.05) to the access point 2.

The QoE reception unit 20 of the access point 2 receives the QoE value (=4.05) from the first wireless terminal 1 and notifies the overall QoE calculation unit 21 of the value.

The overall QoE calculation unit 21 calculates an overall QoE value in accordance with the flowchart of FIG. 2. Since the overall QoE calculation unit 21 has received the second QoE value, the overall QoE (QoE__{EMA}) is updated as follows according to Equation (2) described above (step S130). Here, α in Equation (2) is 0.2.

$${QoE}_{\_ EMA} = α \times QoE + ( 1 - α ) \times {QoE}_{\_ EMA} = 0.2 \times 4.05 + ( 1 - 0.2 ) \times 3.47 = 3.59$$

The overall QoE calculation unit 21 notifies the connection permission unit 22 of the calculated overall QoE value (=3.59).

It is assumed that, at time t3 (10 seconds after time to), there is a connection request to the access point 2 from the third wireless terminal 1c connected to the public mobile communication network in order to switch the connection destination to the access point 2.

The connection permission unit 22 determines whether to permit connection of the third wireless terminal 1c according to the flowchart of FIG. 3. Here, the threshold value THa in FIG. 3 is 3. In this case, since it is determined that the overall QoE value (=3.59) is equal to or greater than the threshold value THa (=3), the connection permission unit 22 permits the connection of the third wireless terminal 1c (step S210). That is, in a case where there is a connection request from the third wireless terminal 1c to the access point 2 and the overall QoE value is equal to or greater than the threshold value THa, the connection permission unit 22 gives permission to switch the connection destination of the third wireless terminal 1c from the public mobile communication network to the access point 2.

Thereafter, the connection destination of the third wireless terminal 1c is switched from the public mobile communication network to the access point 2.

### (5) Effects

As described above, in the system of the present embodiment, a wireless LAN access point evaluates QoE of an already connected wireless terminal prior to connection of a new wireless terminal to the wireless LAN access point. In a case where the QoE of a predetermined level or higher can be guaranteed, the wireless LAN access point permits the new wireless terminal to be connected to the wireless LAN access point. Therefore, it is possible to suppress deterioration in usability of the wireless terminal felt by the user after connection to the wireless LAN access point.

### Second Embodiment

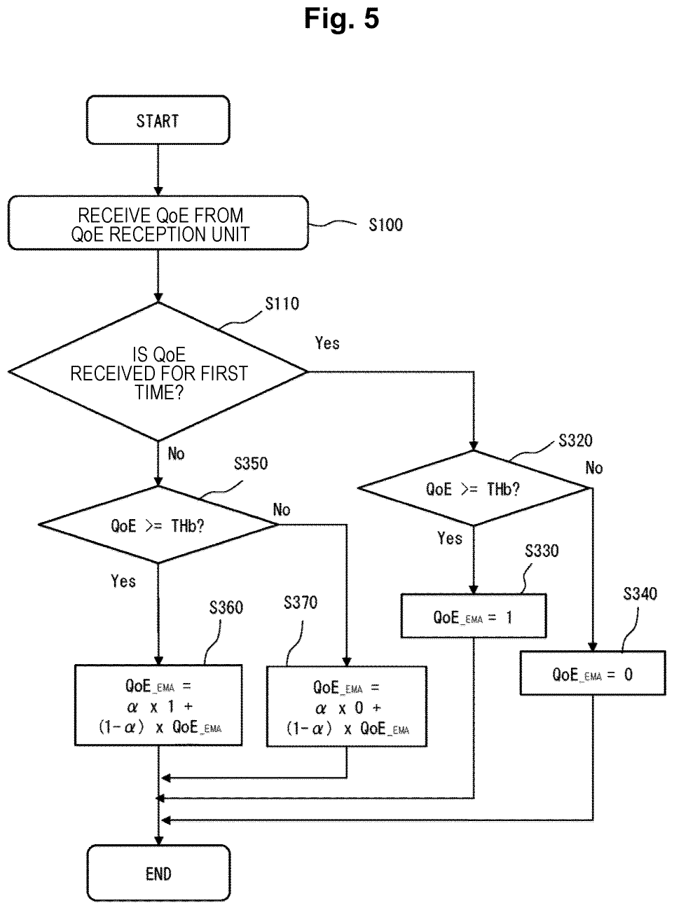

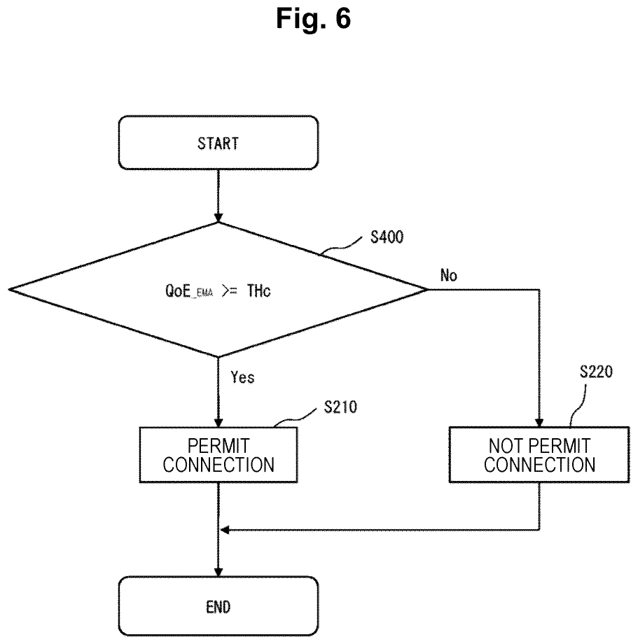

Next, a second embodiment of the present invention will be described with reference to FIG. 5 and FIG. 6.

The wireless communication system according to the second embodiment is similar to that of the first embodiment except that partial processing of the overall QoE calculation unit 21 and the connection permission unit 22 of the access point 2 is different.

### (1) Access Point

The processing of the overall QoE calculation unit 21 according to the second embodiment will be described with reference to FIG. 5.

The overall QoE calculation unit 21 calculates an overall QoE value based on each received QoE value. The overall QoE value is an exponential moving average of the proportion of QoE values equal to or greater than a specified value (threshold value THb) among the received QoE values.

FIG. 5 is a flowchart for illustrating the overall QoE calculation unit 21 according to the second embodiment. The flow illustrated in FIG. 5 is performed each time the access point 2 receives a QoE value from the wireless terminal 1.

In step S100, the overall QoE calculation unit 21 receives the QoE value from the QoE reception unit 20.

In step S110, the overall QoE calculation unit 21 determines whether a QoE value has been received for the first time. In a case where the reception of the QoE value is the first time, the processing of step S320 is executed. On the other hand, in a case where the reception of the QoE value is the second and subsequent times, the processing of step S350 is executed.

First, a case where the QoE value is received for the first time (steps S320 to S340) will be described. In step S320, the overall QoE calculation unit 21 determines whether the QoE value is equal to or greater than the threshold value THb. The threshold value THb is a quality evaluation value of five levels from 1 to 5 described above. In a case where the QoE value is equal to or greater than the threshold value THb, 1 is substituted for the overall QoE value (QoE_{EMA}) (step S330). On the other hand, in a case where the QoE value is less than the threshold value THb, 0 is substituted for the overall QoE value (QoE_{EMA}) (step S340).

Next, a case where the reception of the QoE value is the second and subsequent times (steps S350 to S370) will be described. In step S350, the overall QoE calculation unit 21 determines whether the QoE value is equal to or greater than the threshold value THb. The threshold value THb is a quality evaluation value of five levels from 1 to 5 described above.

In a case where the QoE value is equal to or greater than the threshold value THb, the overall QoE calculation unit 21 updates the overall QoE value (QoE_{EMA}) using the exponential moving average shown in Equation (3) below (step S360). On the other hand, in a case where the QoE value is less than the threshold value THb, the overall QoE calculation unit 21 updates the overall QoE value (QoE_{EMA}) using the exponential moving average shown in Equation (4) below (step S370). Here, a is a constant from 0 to 1. The overall QoE values calculated by Equation (3) and Equation (4) are exponential moving averages of the proportion of QoE values equal to or greater than a specified value (threshold value THb) among the received QoE values.

$$\begin{matrix}[ Math . 3 ] & \\ {Q}^{} {oE}_{EMA} = α \times 1 + ( 1 - α ) \times {Q}^{} {oE}_{EMA} & ( 3 )\end{matrix}$$

$$\begin{matrix}[ Math . 4 ] & \\ {Q}^{} {oE}_{EMA} = α \times 0 + ( 1 - α ) \times {Q}^{} {oE}_{EMA} & ( 4 )\end{matrix}$$

Thereafter, the overall QoE calculation unit 21 notifies the connection permission unit 22 of the overall QoE value.

Processing of the connection permission unit 22 according to the second embodiment will be described with reference to FIG. 6.

The connection permission unit 22 permits connection between the access point 2 and the wireless terminal 1 in the non-connected state in a case where there is a connection request from the wireless terminal 1 in the non-connected state with the access point 2 to the access point 2 and in a case where the overall QoE value (QoE_{EMA}) is equal to or greater than a threshold value THC.

FIG. 6 is a flowchart for illustrating the connection permission unit 22 according to the second embodiment. The flow illustrated in FIG. 6 is performed each time the access point 2 receives a connection request signal from the wireless terminal 1.

The flowchart illustrated in FIG. 6 is the same as the flowchart of FIG. 3 described above except that step S200 is replaced with step S400.

In step S400, the connection permission unit 22 determines whether the overall QoE value (QoE_{EMA}) is equal to or greater than a predetermined threshold value THC. The threshold value THc is a value from 0 to 1. For example, setting the threshold value THc to 0.7 means that a new connection is permitted only when an exponential moving average of a proportion QoE values of a specified value (the threshold value THb in FIG. 5) or more among the received QoE values is 70% or more.

In a case where the overall QoE value (QoE_{EMA}) is equal to or greater than the threshold value THc, the wireless terminal 1 connected to the access point 2 can be guaranteed communication quality of a predetermined level or higher. Therefore, the connection permission unit 22 permits a new connection in step S210. Thereafter, the wireless terminal 1 is newly connected to the access point 2.

On the other hand, in a case where the overall QoE value (QoE_{EMA}) is less than the threshold value THc, the wireless terminal 1 connected to the access point 2 cannot be guaranteed communication quality of a predetermined level or higher. Therefore, the connection permission unit 22 does not permit a new connection in step S220.

### (2) Specific Example

A specific example of connection processing based on the QoE described above in the wireless communication system according to the second embodiment will be described with reference to FIG. 4.

In the example illustrated in FIG. 4, the number of access points 2 is one. The first wireless terminal 1a and the second wireless terminal 1b are connected to the access point 2. The first wireless terminal 1a and the second wireless terminal 1b receive Web traffic as illustrated in FIG. 4. In addition, the third wireless terminal 1c is not connected to the access point 2 and is connected to the public mobile communication network at time t3. The third wireless terminal 1c attempts a new connection to the access point 2 at the time t3. In this specific example, the overall QoE calculation unit 21 follows the flowchart of FIG. 5, and the connection permission unit 22 follows the flowchart of FIG. 6.

At time t1 (5 seconds after time to), the quality measurement unit 10 of the first wireless terminal 1a notifies the QoE calculation unit 11 of the Web waiting time (5 seconds). The QoE calculation unit 11 calculates the QoE value as follows according to Equation (1) above.

$$QoE = 4.179 \times exp ( ( - 5 ) / 9.524 ) + 1. = 3.47$$

The QoE calculation unit 11 notifies the QoE transmission unit 12 of the calculated QoE value (=3.47). The QoE transmission unit 12 transmits the notified QoE value (=3.47) to the access point 2.

The QoE reception unit 20 of the access point 2 receives the QoE value (=3.47) from the first wireless terminal 1a and notifies the overall QoE calculation unit 21 of the value.

The overall QoE calculation unit 21 calculates an overall QoE value in accordance with the flowchart of FIG. 5. The overall QoE calculation unit 21 determines whether the first received QoE value is equal to or greater than the threshold value THb (step S320). Here, the threshold value THb is set to 3. In this case, since it is determined that the QoE value (=3.47) is equal to or greater than the threshold value THb (=3), the overall QoE calculation unit 21 substitutes 1 for the overall QoE value (step S340). The overall QoE calculation unit 21 notifies the connection permission unit 22 of the calculated overall QoE value (=1).

At time t2 (8 seconds after time to), the quality measurement unit 10 of the second wireless terminal 1b notifies the QoE calculation unit 11 of the Web waiting time (3 seconds). The QoE calculation unit 11 calculates the QoE value as follows according to Equation (1) above.

$$QoE = 4.179 \times exp ( ( - 3 ) / 9.524 ) + 1. = 4.05$$

The QoE calculation unit 11 notifies the QoE transmission unit 12 of the calculated QoE value (=4.05). The QoE transmission unit 12 transmits the notified QoE value (=4.05) to the access point 2.

The QoE reception unit 20 of the access point 2 receives the QoE value (=4.05) from the second wireless terminal 1b and notifies the overall QoE calculation unit 21 of the value.

The overall QoE calculation unit 21 calculates an overall QoE value in accordance with the flowchart of FIG. 5. The overall QoE calculation unit 21 determines whether the second received QoE value is equal to or greater than the threshold value THb (step S350). Here, the threshold value THb is set to 3. In this case, since it is determined that the QoE value (=4.05) is equal to or greater than the threshold value THb (=3), the overall QoE calculation unit 21 updates the overall QoE value (QoE__{EMA}) as follows according to Equation (3) described above (step S360). Here, α in Equation (3) is 0.2.

$${QoE}_{\_ EMA} = α \times 1 + ( 1 - α ) \times {QoE}_{\_ EMA} = 0.2 \times 1 + ( 1 - 0.2 ) \times 1 = 1$$

The overall QoE calculation unit 21 notifies the connection permission unit 22 of the calculated overall QoE value (=1).

It is assumed that, at time t3 (10 seconds after time to), there is a connection request to the access point 2 from the third wireless terminal 1c connected to the public mobile communication network in order to switch the connection destination to the access point 2.

The connection permission unit 22 determines whether to permit connection of the third wireless terminal 1c according to the flowchart of FIG. 6. Here, the threshold value THc in FIG. 6 is 0.7. In this case, since it is determined that the overall QoE value (=1) is equal to or greater than the threshold value THC (=0.7), the connection permission unit 22 permits the connection of the third wireless terminal 1c. That is, in a case where there is a connection request from the third wireless terminal 1c to the access point 2 and the overall QoE value is equal to or greater than the threshold value THc, the connection permission unit 22 gives permission to switch the connection destination of the third wireless terminal 1c from the public mobile communication network to the access point 2.

Thereafter, the connection destination of the third wireless terminal 1c is switched from the public mobile communication network to the access point 2.

### (3) Effects

As described above, according to the system of the present embodiment, a wireless LAN access point evaluates QoE of an already connected wireless terminal prior to connection of a new wireless terminal to the wireless LAN access point. The wireless LAN access point permits connection of a new wireless terminal only when an exponential moving average (overall QoE value) of a proportion of QoE values equal to or greater than a specified value (threshold value THb) among the received QoE values is equal to or greater than a predetermined proportion (threshold value THc). Therefore, it is possible to suppress deterioration in usability of the wireless terminal felt by the user after connection to the wireless LAN access point.

### Third Embodiment

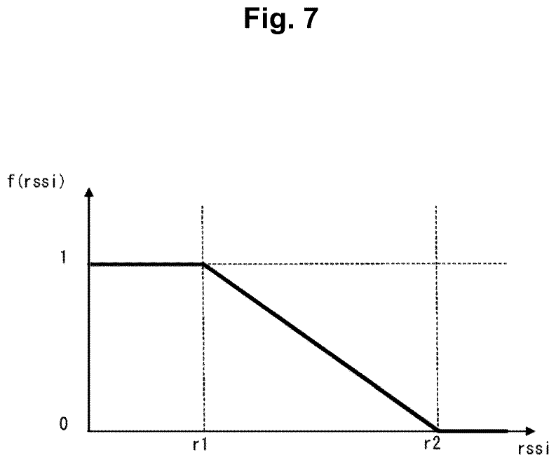

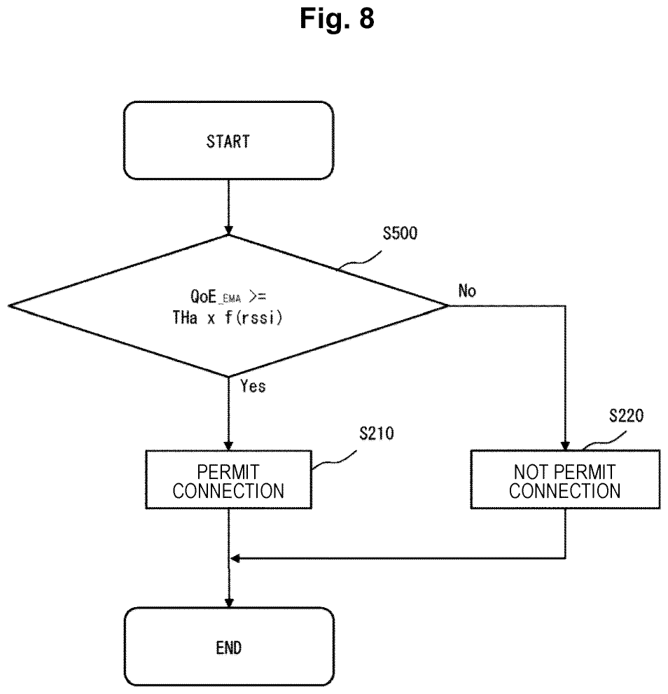

Next, a third embodiment of the present invention will be described with reference to FIG. 7 and FIG. 8.

The wireless communication system according to the third embodiment is similar to that of the first embodiment except that partial processing of the connection permission unit 22 of the access point 2 is different.

### (1) Access Point

The connection permission unit 22 according to the third embodiment realizes connection control in consideration of not only QoE but also a received signal strength indicator (RSSI).

The connection permission unit 22 permits connection between the access point 2 and the wireless terminal 1 in the non-connected state in a case where there is a connection request from the wireless terminal 1 in the non-connected state with the access point 2 to the access point 2 and in a case where the overall QoE value is equal to or greater than a threshold value. Here, the threshold value is a value obtained by multiplying the threshold value THa regarding the overall QoE value by a function f (rssi) whose value decreases as a received signal strength indicator (RSSI) of the wireless terminal in the non-connected state increases. That is, the connection permission unit 22 determines whether the overall QoE value is equal to or greater than a value obtained by multiplying the threshold value THa by the function f (rssi), and permits the connection in a case where the determination condition is satisfied, and does not permit the connection in a case where the determination condition is not satisfied. The function f(rssi) is expressed by Equation (5) below.

$$\begin{matrix}[ Math . 5 ] & \\ f ( rssi ) = \frac{- rssi + r 2}{r 2 - r 1} & ( 5 )\end{matrix}$$

FIG. 7 is a graph of the function f(rssi). As illustrated in FIG. 7, f(rssi) is a function that takes 1 in a case where rssi is equal to or less than r1, takes 0 in a case where rssi is equal to or greater than r2, and takes a value determined by Equation (5) in a case between r1 and r2. f(rssi) is a function having a smaller value as rssi is higher, and the wireless terminal 1 having a higher RSSI more easily satisfies the determination condition, so that connection is easy.

Processing of the connection permission unit 22 according to the third embodiment will be described with reference to FIG. 8. FIG. 8 is a flowchart for illustrating the connection permission unit 22 according to the third embodiment. The flow illustrated in FIG. 8 is performed each time the access point 2 receives a connection request signal from the wireless terminal 1. The RSSI can be obtained from the received signal strength when the access point 2 receives the connection request signal of the wireless terminal 1.

The flowchart illustrated in FIG. 8 is the same as the flowchart of FIG. 3 described above except that step S500 is replaced with step S200.

In step S500, the connection permission unit 22 determines whether the overall QoE value (QoE_{EMA}) is equal to or greater than a value obtained by multiplying the predetermined threshold value THa by f (rssi) shown in Equation (5). The threshold value THa is a quality evaluation value of five levels from 1 to 5 as described above. f(rssi) is a function having a smaller value as rssi is higher, and the wireless terminal 1 having a higher RSSI is more likely to satisfy the determination condition in step S500.

In a case where the overall QoE value (QoE_{EMA}) satisfies the determination condition of step S500, the connection permission unit 22 permits a new connection in step S210. Thereafter, the wireless terminal 1 is newly connected to the access point 2.

On the other hand, in a case where the overall QoE value (QoE_{EMA}) does not satisfy the determination condition of step S500, the connection permission unit 22 does not permit a new connection in step S220.

### (2) Specific Example

A specific example of connection processing based on the QoE described above in the wireless communication system according to the third embodiment will be described with reference to FIG. 4.

In the example illustrated in FIG. 4, the number of access points 2 is one. The first wireless terminal 1a and the second wireless terminal 1b are connected to the access point 2. The first wireless terminal 1a and the second wireless terminal 1b receive Web traffic as illustrated in FIG. 4. In addition, the third wireless terminal 1c is not connected to the access point 2 and is connected to the public mobile communication network at time t3. The third wireless terminal 1c attempts a new connection to the access point 2 at the time t3. In this specific example, the overall QoE calculation unit 21 follows the flowchart of FIG. 2, and the connection permission unit 22 follows the flowchart of FIG. 8.

At time t1 (5 seconds after time to), the quality measurement unit 10 of the first wireless terminal 1a notifies the QoE calculation unit 11 of the Web waiting time (5 seconds). The QoE calculation unit 11 calculates the QoE value as follows according to Equation (1) above.

$$QoE = 4.179 \times exp ( ( - 5 ) / 9.524 ) + 1. = 3.47$$

The QoE calculation unit 11 notifies the QoE transmission unit 12 of the calculated QoE value (=3.47). The QoE transmission unit 12 transmits the notified QoE value (=3.47) to the access point 2.

The QoE reception unit 20 of the access point 2 receives the QoE value (=3.47) from the first wireless terminal 1 and notifies the overall QoE calculation unit 21 of the value.

The overall QoE calculation unit 21 calculates an overall QoE value in accordance with the flowchart of FIG. 2. Since the overall QoE calculation unit 21 receives the QoE value for the first time, it substitutes the received QoE value (=3.47) for the overall QoE value (step S120). The overall QoE calculation unit 21 notifies the connection permission unit 22 of the calculated overall QoE value (=3.47).

At time t2 (8 seconds after time to), the quality measurement unit 10 of the second wireless terminal 1b notifies the QoE calculation unit 11 of the Web waiting time (3 seconds). The QoE calculation unit 11 calculates the QoE value as follows according to Equation (1) above.

$$QoE = 4.179 \times exp ( ( - 3 ) / 9.524 ) + 1. = 4.05$$

The QoE calculation unit 11 notifies the QoE transmission unit 12 of the calculated QoE value (=4.05). The QoE transmission unit 12 transmits the notified QoE value (=4.05) to the access point 2.

The QoE reception unit 20 of the access point 2 receives the QoE value (=4.05) from the first wireless terminal 1 and notifies the overall QoE calculation unit 21 of the value.

The overall QoE calculation unit 21 calculates an overall QoE value in accordance with the flowchart of FIG. 2. Since the overall QoE calculation unit 21 has received the second QoE value, the overall QoE (QoE EMA) is updated as follows according to Equation (2) described above (step S130). Here, a in Equation (2) is 0.2.

$${QoE}_{\_ EMA} = α \times QoE + ( 1 - α ) \times {QoE}_{\_ EMA} = 0.2 \times 4.05 + ( 1 - 0.2 ) \times 3.47 = 3.59$$

The overall QoE calculation unit 21 notifies the connection permission unit 22 of the calculated overall QoE value (=3.59).

It is assumed that, at time t3 (10 seconds after time t0), there is a connection request to the access point 2 from the third wireless terminal 1c connected to the public mobile communication network in order to switch the connection destination to the access point 2.

The connection permission unit 22 determines whether to permit connection of the third wireless terminal 1c according to the flowchart of FIG. 8. Here, it is assumed that threshold values THa=3, r1=−80, r2=−30, and rssi=−50. The connection permission unit 22 calculates f (rssi) as follows according to Equation (5) described above.

$$f ( rssi ) = ( - rssi + r 2 ) / ( r 2 - r 1 ) = ( 50 - 30 ) / ( - 30 + 80 ) = 0.4$$

In this case, a value obtained by multiplying the threshold value THa by f (rssi) is “3×0.4=1.2”. Since it is determined that the total QoE (=3.59) is equal to or greater than the value (=1.2), the connection permission unit 22 permits the connection of the third wireless terminal 1c (step S210). That is, in a case where there is a connection request from the third wireless terminal 1c to the access point 2 and the overall QoE value is equal to or greater than a value obtained by multiplying f (rssi) by the threshold value THa, the connection permission unit 22 gives permission to switch the connection destination of the third wireless terminal 1c from the public mobile communication network to the access point 2.

Thereafter, the connection destination of the third wireless terminal 1c is switched from the public mobile communication network to the access point 2.

### (3) Effects

As described above, in the system of the present embodiment, the same effects as those of the first embodiment are obtained. In particular, in the system of the present embodiment, the threshold value (THa×f(rssi)) related to the overall QoE value can be dynamically changed according to the RSSI, and the wireless terminal having a higher RSSI is more likely to be permitted to connect to the wireless LAN access point.

### (4) Modification Examples

The connection permission unit 22 according to the third embodiment may be applied to the connection permission unit 22 according to the second embodiment. In this case, the threshold value THa in step S500 is replaced with the threshold value THc.

### (Hardware Configuration Example)

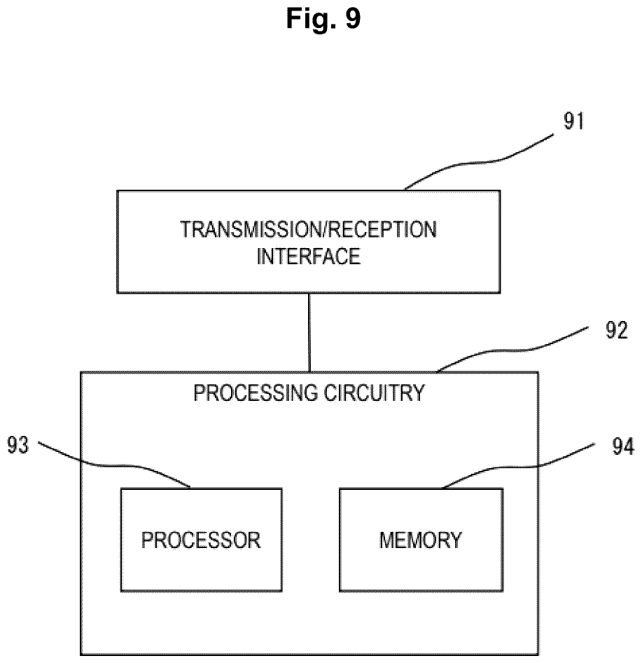

FIG. 9 is a block diagram illustrating a configuration example of a wireless terminal 1 and an access point 2 according to the present embodiment. Each of the wireless terminal 1 and the access point 2 includes a transmission/reception interface 91 and processing circuitry 92. The transmission/reception interface 91 transmits and receives signals to and from the outside.

The processing circuitry 92 performs various types of information processing. For example, the processing circuitry 92 includes a processor 93 and a memory 94. The processor 93 performs various types of information processing. For example, the processor 93 includes a central processing unit (CPU). The memory 94 stores various types of information necessary for processing by the processor 93. Examples of the memory 94 include a volatile memory, nonvolatile memory, hard disk drive (HDD), and solid state drive (SSD).

The processing circuitry 92 may be implemented with the use of hardware such as an application specific integrated circuit (ASIC), a programmable logic device (PLD), or a field programmable gate array (FPGA).

Although the embodiments of the present invention have been described above, the present invention is not limited to the above-described embodiments, and various modifications can be made without departing from the gist of the present invention. In a case where the number, numerical quantity, quantity, range, and the like of each component are specified in the embodiments described above, the present invention is not limited to the numbers mentioned, unless they are explicitly stated or the numbers are clearly specified in principle. Further, the structures and the like described in the above embodiments are not necessarily essential to the present invention, unless it is explicitly stated or the present invention is clearly limited to them in principle.

### REFERENCE SIGNS LIST

1 Wireless terminal
1a First wireless terminal
1b Second wireless terminal
1c Third wireless terminal
1n N-th wireless terminal
2 Access point
10 Quality measurement unit
11 QoE calculation unit
12 QoE transmission unit
20 QoE reception unit
21 Overall QoE calculation unit
22 Connection permission unit
91 Transmission/reception interface
92 Processing circuitry
93 Processor
94 Memory
THa, THb, THE Threshold value

1. A wireless terminal connection control method for a wireless LAN access point and a plurality of wireless terminals having wireless interfaces of both a wireless LAN and a public mobile communication network, the method comprising:
receiving a quality of experience (QoE) value indicating communication quality of the wireless LAN felt by a user from each of the wireless terminals connected to the wireless LAN access point;
calculating an overall QoE value based on each of the received QoE values; and
permitting connection between the wireless LAN access point and the wireless terminal in a non-connected state in a case where there is a connection request from the wireless terminal in the non-connected state with the wireless LAN access point to the wireless LAN access point and in a case where the overall QoE value is equal to or greater than a threshold value.

2. The wireless terminal connection control method according to claim 1, wherein the overall QoE value is an exponential moving average of each received QoE value.

3. The wireless terminal connection control method according to claim 1, wherein the overall QoE value is an exponential moving average of a proportion of QoE values equal to or greater than a specified value among the received QoE values.

4. The wireless terminal connection control method according to claim 1, wherein the threshold value is a value obtained by multiplying a first threshold value related to the overall QoE value by a function in which a value becomes smaller as a received signal strength indicator (RSSI) of the wireless terminal in the non-connected state becomes higher.

5. The wireless terminal connection control method according to claim 1, wherein the QoE value is a degradation mean opinion score (DMOS) calculated based on a time from a start to an end of reading of a web page.

6. The wireless terminal connection control method according to claim 1, wherein
the wireless terminal in the non-connected state is in a non-connected state with a wireless LAN access point and in a connected state with the public mobile communication network, and
the permitting connection comprises permitting switching of the connection destination of the wireless terminal in the non-connected state from the public mobile communication network to the wireless LAN access point in a case where there is a connection request from the wireless terminal in the non-connected state to the wireless LAN access point and in a case where the overall QoE value is equal to or greater than the threshold value.
